(19) United States
(12) Patent Application Publication
(10) Pub. No.: US 2011/0179700 A1
(43) Pub. Date: Jul. 28, 2011

(54) System and Method for Torrefaction and Processing of Biomass

(76) Inventors: James Russell Monroe, Fairview, TX (US); David Thomas Schroeder, Watertown, WI (US)

(21) Appl. No.: 13/083,172

(22) Filed: Apr. 8, 2011

Related U.S. Application Data
(63) Continuation of application No. PCT/US11/29159, filed on Mar. 21, 2011.
(60) Provisional application No. 61/316,214, filed on Mar. 22, 2010.

(51) Int. Cl. C10L 5/40; B01J 19/00

(52) U.S. Cl. 44/589; 422/198

(57) ABSTRACT

In accordance with some embodiments of the present disclosure, a system may include a preheater, a torrefaction reactor, and a furnace. The preheater may be configured to heat biomass from a first temperature to an approximate desired torrefaction temperature. The torrefaction reactor may be configured to maintain heating of the biomass at approximately the approximate desired torrefaction temperature for a particular period of time to generate torrefied biomass. The furnace may be configured to generate and convey via one or more conduits heat to the preheater, and the torrefaction reactor.

### RELATED APPLICATION

This application is a continuation of International Application PCT/US11/29159 filed Mar. 21, 2011; which claims the benefit of U.S. Provisional Application No. 61/316,214, filed Mar. 22, 2010, which is incorporated by reference herein in its entirety.

### TECHNICAL FIELD

The present disclosure relates generally to torrefaction and processing of biomass and, more particularly, to a system and method for production of torrefied and densified biomass employing substantially autothermal torrefaction.

### BACKGROUND

In general, the term “biomass” can be used to include all organic matter (e.g., all matter that originates from photosynthesis). Biomass can include wood, plants, vegetable oils, green waste, manure, sewer sludge, or any other form or type of organic matter.

Biomass may be transformed by heat in a low oxygen environment, by a process known as torrefaction, into a hydrophobic, decay-resistant material that may be used as a fuel (e.g., as a coal fuel substitute, a feedstock for entrained-flow gasification, or other fuel), a soil additive, a long-term carbon storage mechanism, or for other suitable use. In particular, torrefied biomass may be used in existing fuel-burning power plants (e.g., coal-burning power plants), thus facilitating the use of renewable fuels with existing fuel-burning infrastructure to generate electricity. In addition, use of torrefied biomass as a fuel may provide a carbon-neutral means of providing energy, as it does not add carbon to the atmosphere.

Torrefaction of biomass may be described as a mild form of pyrolysis at temperatures typically ranging between 230°-320° C. During torrefaction, water present in the biomass may evaporate and biopolymers (e.g., cellulose, hemicellulose, and lignin) of the biomass may partially decompose, giving off various types of volatile organic compounds (referred to as “torgas”), resulting in a loss of mass (e.g., approximately 30%) and chemical energy (e.g., approximately 10%) in the gas phase.

However, because more mass than energy is lost, torrefaction results in energy densification, yielding a solid product with lower moisture content and higher energy content compared to untreated biomass. The resulting product may be solid, dry, dark brown or blackened material which is referred to as “torrefied wood”, “torrefied biomass” or “biocoal.”

Biocoal may have more energy density than non-torrefied biomass, resulting in reduced transportation and handling costs, and other economic advantage. To further improve transportation efficiencies, torrefied biomass may be “densified” by pelletization and/or briquetting. Due to the increased ease of handling and energy densification of densified, torrefied biomass, and the fact that some sources of biomass may be sustainable or reclaimed materials, biocoal has increasingly received attention as a “green,” carbon-neutral, environmentally-friendly energy solution.

Many other characteristics of biocoal enable it to be a viable green energy solution. For example, biomass can be produced from a wide variety of raw biomass feedstocks while yielding similar product properties. In addition, torrefied biomass has hydrophobic properties, and when combined with densification make bulk storage in open air feasible. Further, torrefaction leads to the elimination of biological activity, reducing the risk of spontaneous combustion and ceasing biological decomposition. Moreover, torrefaction of biomass allows for improved grindability of biomass, leading to more efficient co-firing in existing coal-fired power plants or entrained-flow gasification for the production of chemicals and transportation fuels.

However, despite such advantages, many existing torrefaction processes and systems have numerous disadvantages. For example, existing processes and systems may heavily rely on traditional, non-sustainable fuels (e.g., petroleum products, natural gas) to provide heat for torrefaction, thus disadvantageously offsetting the environmentally-friendly aspects of torrefying biomass. Further, the means by which heat is transferred into the biomass in some systems results in an inconsistently torrefied material. In addition, torrefaction often produces numerous substances (e.g., condensates and tars) that may adhere to or collect on various components of a torrefaction system, which may lead to decreased operability of such components or challenges in cleaning such components. Moreover, the process of stabilizing torrefied biomass after heating in order to prevent combustion often takes significant amount of time using traditional approaches, leading to slow throughput.

### SUMMARY

In accordance with some embodiments of the present disclosure, a system may include a preheater, a torrefaction reactor, and a furnace. The preheater may be configured to heat biomass from a first temperature to an approximate desired torrefaction temperature. The torrefaction reactor may be configured to maintain heating of the biomass at approximately the approximate desired torrefaction temperature for a particular period of time to generate torrefied biomass. The furnace may be configured to generate and convey via one or more conduits heat to the preheater, and the torrefaction reactor.

In accordance with additional embodiments of the present disclosure, a system may include a torrefaction reactor and a stabilizer/conditioner. The torrefaction reactor configured to heat biomass generate torrefied biomass. The stabilizer/conditioner may be configured to substantially simultaneously stabilize and condition the torrefied biomass.

In accordance with additional embodiments of the present disclosure a method may be provided. The method may include: (i) heating, in a torrefaction reactor, biomass to generate torrefied biomass; (ii) generating and conveying via one or more heat conduits heat from a furnace to the torrefaction reactor; (iii) combusting, in the furnace, one or more volatile organic compounds generated by the torrefaction reactor to generate at least a portion of the heat; (iv) circulating, via one or more fluid conduits, the one or more volatile organic compounds from the torrefaction reactor to the furnace; and (v) heating the one or more fluid conduits such that a temperature of the volatile organic compounds while present in the one or more fluid conduits remains above a dew point of the volatile organic compounds.

Technical advantages of the present disclosure may be readily apparent to one skilled in the art from the figures, description and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a flow diagram of an example method for harvesting and preparing biomass for torrefaction, in accordance with certain embodiments of the present disclosure;

FIG. 2 illustrates a block diagram of selected components of an example torrefaction system, in accordance with certain embodiments of the present disclosure;

FIG. 3 illustrates a schematic diagram of an example stabilizer/conditioner, in accordance with certain embodiments of the present disclosure;

FIG. 4 illustrates a schematic diagram depicting an example arrangement of selected components of the torrefaction system of FIG. 1, in accordance with certain embodiments of the present disclosure; and

FIG. 5 illustrates a flow diagram of an example torrefaction and densification process, in accordance with certain embodiments of the present disclosure.

### DETAILED DESCRIPTION

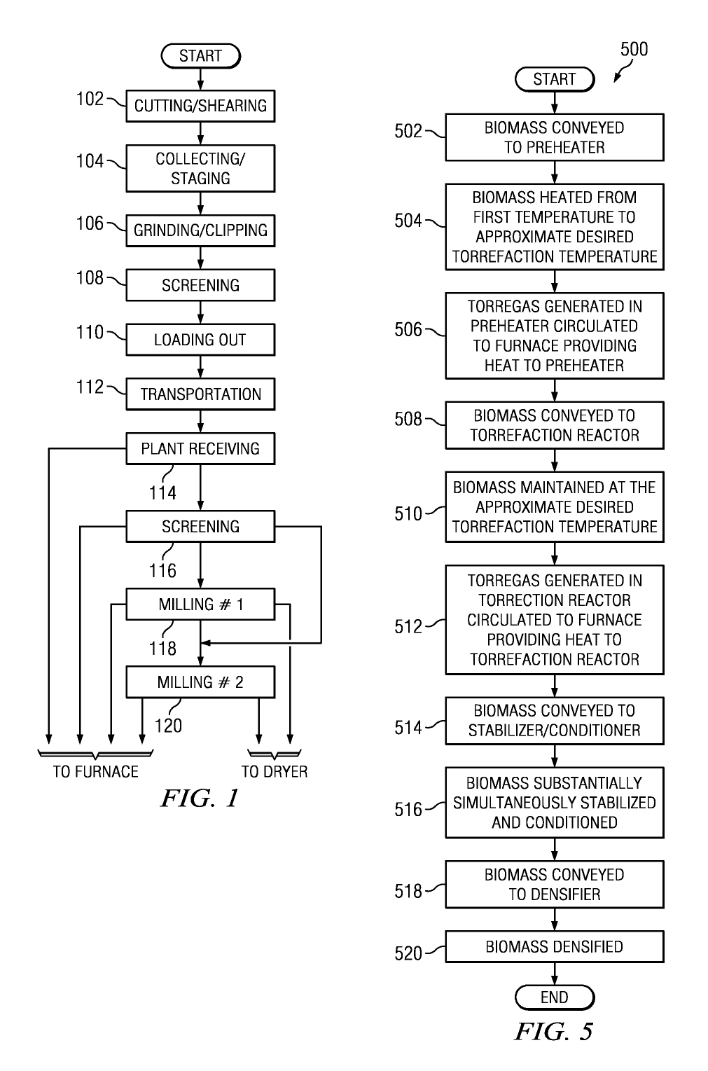

Preferred embodiments and their advantages are best understood by reference to FIGS. 1-5, wherein like numbers are used to indicate like and corresponding parts.

FIG. 1 illustrates a flow diagram of an example method 100 for harvesting and processing biomass for torrefaction, in accordance with certain embodiments of the present disclosure. According to certain embodiments, method 100 may begin at block 102. Teachings of the present disclosure may be implemented in a variety of configurations. Although FIG. 1 discloses a particular number of steps to be taken with respect to method 100, method 100 may be executed with greater or lesser steps than those depicted in FIG. 1. In addition, although FIG. 1 discloses a certain order of steps to be taken with respect to method 100, the steps comprising method 100 may be completed in any suitable order.

Method 100 may start with field harvesting of biomass. In certain embodiments, harvesting may begin with cutting or shearing 102 of trees or other plants. As used in the context of harvesting woody and plant-based biomass, cutting or shearing may refer to harvesting a plant such that the root system of the plant remains embedded in soil. Cutting or shearing may allow for sustainable harvesting of species of plants that may re-propagate or re-grow after being cut or sheared. For example, many species of trees including mesquite, fast-growing hardwoods, and bamboo, may grow shunts from the roots, remaining trunk of a cut or sheared tree or other plant, thus providing for later re-harvesting from the same plant or tree at a later time. As a specific example, biomass may be efficiently harvested from a single mesquite tree approximately once every 10 years.

Harvesting may continue with collecting and staging 104 of the cut or sheared biomass. Collecting and staging may include collecting, with appropriate equipment, the cut or sheared biomass and staging (e.g., stacking, transporting) for grinding or chipping. Grinding or chipping 106 may include using a commercially-available wood hog, wood grinder, wood chipper, or other similar apparatus that may receive collected biomass as an input and produce as output chips (e.g., wood chips) of a desired size (e.g., a maximum length of approximately ten to fifteen centimeters in any dimension. Grinding or chipping of biomass in the field may increase the volume of biomass that may be transported from a harvest site by a truck, trailer, or other vehicle.

In some embodiments, after grinding or chipping of biomass, biomass chips may be subject to screening in the field 108. Screening may be performed by one or more screening systems and/or other similar devices capable of segregating chips by size, weight, shape and/or other physical characteristics. Screening, if utilized, may segregate biomass chips unsuitable for conversion into biocoal and remove undesirable material (e.g., dirt, sand, etc.) or foreign objects (e.g., rocks, tramp metal, etc.).

After grinding or chipping 106 (and after field screening 108, in embodiments in which screening in the field is applied), biomass chips may be loaded 110 into trucks, trailers, and/or other vehicles for transportation 112 to a plant for further processing, including torrefaction. At the completion of transportation 112 from the field, biomass may be received 114 at a plant. As used herein, “plant” is used generally to refer to any plant, chipyard, and/or any other suitable facility for processing biomass to produce biocoal. Upon receipt at a plant, biomass may be stored in bins, containers, in piles, and/or in any other suitable manner.

Following receipt at the plant, screening 116 may be applied to the biomass. Screening may be performed manually based on observed characteristics of biomass chips, or may be performed by one or more screening systems, masks, and/or other similar devices capable of segregating chips by size, weight, shape, and/or other characteristics. Screening, if utilized, may segregate biomass chips into those deemed unsuitable for torrefaction and conversion into biocoal (“rejects”), those requiring milling to a smaller size suitable for torrefaction and conversion into biocoal (e.g., “oversized” chips that are greater than is deemed appropriate), and those suitable for torrefaction (“accepts”).

Biomass chips determined to be oversized by plant screening 116 may be conveyed or otherwise transported to a hammermill or other suitable apparatus for milling 118 and/or 120.

Oversized chips may be reduced in size by milling 118 and/or milling 120. For example, screening 116 may further segregate oversized chips into two groups, one of which may include oversized chips larger than chips of the other group. The group of larger chips may be fed for milling 118 while the smaller group of chips may be fed for milling 120. Chips milled in milling 118 may be further screened (not shown) to determine those that are “accepts” after milling 118 and those requiring further milling 120. Although not depicted, additional screening may be performed after milling 118 and/or 120 to again segregate chips into accepts, rejects, and/or oversized. If chips remained oversized after milling 118 and/or 120, such chips may be again fed for milling 118 and/or 120.

After the harvesting and processing of method 100 is complete, biomass “accepts” may be conveyed to dryer 204 of system 200, where such accepts may be used as a feedstock for torrefaction, and “rejects” from screening 116, milling 118, and/or milling 120 may be conveyed to furnace 222 of system 200, where such rejects may be used as solid, untorrefied fuel for furnace 222. In some embodiments, biomass other than rejects may be conveyed to furnace 222 as fuel. For example, in some embodiments, unscreened biomass from receiving 114 may be conveyed to furnace 222 as fuel. After application of method 100, surge bins may be used to hold biomass to be used as feedstock for torrefaction and/or to hold biomass to be used as solid fuel.

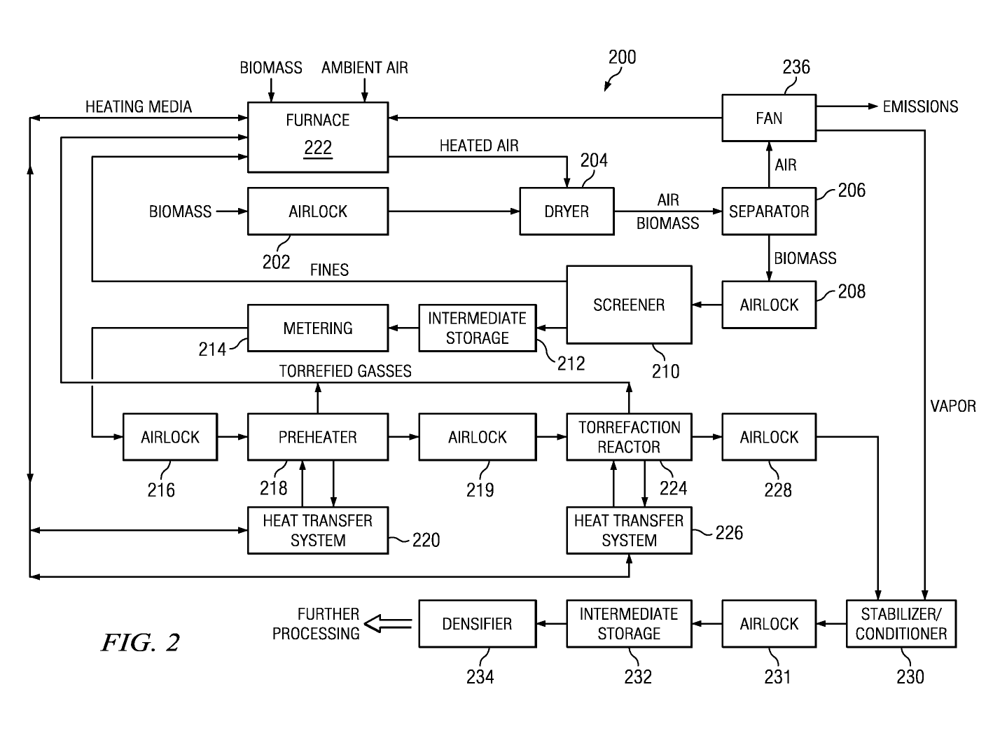

FIG. 2 illustrates a block diagram of selected components of an example torrefaction system 200, in accordance with certain embodiments of the present disclosure. As shown in FIG. 2, torrefaction system 200 may include airlocks 202, 208, 216, 219, 228, and 231, dryer 204, separator 206, screener 210, intermediate storages 212, 232, meter 214, preheater 218, heat transfer systems 220, 226, furnace 222, torrefaction reactor 224, stabilizer/conditioner 230, densifier 234, and fan 236. In addition, although not explicitly depicted in FIG. 2 for the purpose of clarity, torrefaction system 200 may include any number and any suitable types of conveyors configured to convey biomass and/or other material between or within various components of torrefaction system 200. Each of such conveyors may include a chain conveyor, belt conveyor, drag conveyor, vibratory conveyor, walking-floor conveyor, piston conveyor, screw conveyor, pneumatic transfer conveyor, and/or any other suitable conveyance system for transporting biomass and/or other material.

A suitable conveyor may convey biomass to airlock 202. Airlock 202 may comprise any device that may permit the passage of biomass to dryer 204 (e.g., biomass accepts from screening 116, milling 118, 120, a surge bin, and/or other storage) while minimizing exchange of gas between the space internal to dryer 204 and the space external to dryer 204, such that the gas flow needed to convey biomass through the dryer 204 is drawn entirely from the furnace 222 and not from the surrounding environment. For example, airlock 202 may include an airlock, feeder, load lock, or other suitable device. In certain embodiments, airlock 202 may comprise a rotary airlock, thus permitting substantially continuous conveyance of biomass into dryer 204 via airlock 202.

Dryer 204 may include any suitable device for drying biomass (e.g., biomass accepts from screening 116, milling 118, 120, a surge bin, and/or other storage). Dryer 204 may include an oven, kiln, and/or other suitable heating apparatus. In some embodiments, dryer 204 may include a direct-fired triple-pass rotary biomass dryer, such as that commercially available from Baker-Rullman Manufacturing Inc., for example. As shown in FIG. 2, and described in greater detail below, dryer 204 may receive heat from furnace 222 via any suitable thermal conduit. Such heat may be generated by furnace 222 and transferred via a thermal conduit by air (e.g., by means of a fan or blower), thermally-conductive oil, or other fluid present in the conduit, in order to transfer heat to the biomass via conductive, convective and/or radiant heat transfer. Using such heat, dryer 202 may reduce the moisture content of biomass conveyed to dryer 202 (e.g., to a desired moisture content of approximately 5% to approximately 10%).

During the drying process, biomass may give off water vapor, light volatile organic compounds (VOCs), biomass particulates, and/or other matter. Accordingly, biomass and air within dryer 204 may be conveyed to separator 206. Separator 206 may include any device configured to separate gasses and particulates (e.g., water vapor, VOCs and/or biomass particulates) from larger, solid biomass. In some embodiments, separator 206 may include a cyclone configured to separate biomass from air using cyclonic separation. As shown in FIG. 2, a portion of the separated gasses and particulates may be vented (e.g., via fan 236 and/or suitable conduits) for discharge into the environment as emissions. In addition, also as shown in FIG. 2, a portion of the separated gasses and particulates may be re-circulated (e.g., via fan 236 and/or suitable conduits) to furnace 222, as described in greater detail below, in order to prevent environmental pollution that may be caused by excessive discharge of VOCs, vapors, and/or particulates. Furthermore, again as shown in FIG. 2, a portion of the vapor separated by separator 206 may be circulated to stabilizer/conditioner 230 (e.g., via fan 236 and/or suitable conduits), in order to provide heat to internal space of stabilizer/conditioner 230 in order to maintain a desired temperature of torrefied biomass in stabilizer/conditioner 230.

A suitable conveyor may convey dried, separated biomass from separator 206 to airlock 208. Airlock 208 may comprise any device that may permit the passage of biomass between separator 206 and screener 208 while minimizing exchange of gas between the space internal to separator 206 and the space external to separator 206, such that separator 206 efficiently separates solids from gas. For example, airlock 208 may include an airlock, feeder, load lock, or other suitable device. In certain embodiments, airlock 208 may comprise a rotary airlock, thus permitting substantially continuous conveyance of biomass from separator 206 to screener 210.

Screener 210 may include any device configured to separate received biomass by size, weight, shape, and/or other characteristic in order to segregate biomass particles into those deemed unsuitable for torrefaction and conversion into biocoal (“fines”) and those suitable for torrefaction. Screener 210 may include a screening system, masks, and/or other similar device. A suitable conveyor may convey fines from screener 210 to furnace 222, where such fines may be used as solid fuel for furnace 222, as described in greater detail below. Another suitable conveyor may convey remaining biomass to intermediate storage 212.

Intermediate storage 212 may include any suitable container for temporarily storing biomass prior to conveyance to meter 214. In some embodiments, intermediate storage 212 may comprise a surge bin. A suitable conveyor may convey biomass from intermediate storage 212 to meter 214.

Meter 214 may include any device configured to measure (e.g., by weight, volume, or other suitable characteristic) a desired amount of biomass to be conveyed to preheater 218 and torrefaction reactor 224. A suitable conveyor may convey a desired amount of biomass to airlock 216.

Airlock 216 may comprise any device that may permit the passage of biomass between meter 214 and preheater 218 while minimizing exchange of gas between the space internal to preheater 218 and the space external to preheater 218, in order to ensure the space internal to preheater 218 remains a substantially oxygen-deprived environment (e.g., an oxygen content at or below approximately 2% in some embodiments). For example, airlock 216 may include an airlock, feeder, load lock, or other suitable device. In certain embodiments, airlock 216 may comprise a rotary airlock, thus permitting substantially continuous conveyance of biomass from meter 214 to preheater 218.

Preheater 218 may include any oven, kiln, or other suitable heating apparatus suitable for heating biomass to a desired temperature (e.g., approximately 230° C. to approximately 280° C.) over a desired period of time (e.g., approximately 5 minutes to approximately 30 minutes) in an oxygen deprived-environment (e.g., an oxygen content at or below approximately 2% in some embodiments) for preheating the biomass to a desired temperature for torrefaction. Preheater 218 may include a suitable conveyor for conveying biomass (e.g., including a substantially continuous stream of biomass) from an input of preheater 218 (e.g., proximate to airlock 216) to an output of preheater 218 (e.g., proximate to airlock 219). As shown in FIG. 2, and described in greater detail below, preheater 218 may receive heat from heat transfer system 220. Heat received via heat transfer system 220 may be used to heat biomass in preheater 218 via conductive, convective, and/or radiant heat transfer.

Heat transfer system 220 may be any suitable device configured to transfer heat from a thermally-conductive conduit coupled between furnace 222 and heat transfer system 220. Accordingly, heat generated by furnace 222 may be transferred via the conduit by air (e.g., by means of a fan or blower), thermally-conductive oil, or other fluid present in the conduit, from which it may be transferred to preheater 218 via heat transfer system 220. In certain embodiments, heat transfer system 220 may use electric block heaters directly attached to preheater 218 and the heat from furnace 222 may be used to create electricity for the block heaters as opposed to provide heat directly to preheater 218.

Airlock 219 may comprise any device that may permit the passage of biomass between preheater 218 and torrefaction reactor 224 while minimizing exchange of gas between preheater 218 and torrefaction reactor 224, in order to provide thermal isolation between preheater 218 and torrefaction reactor 224. For example, airlock 219 may include an airlock, feeder, load lock, or other suitable device. In certain embodiments, airlock 219 may comprise a rotary airlock, thus permitting substantially continuous conveyance of biomass from preheater 218 to torrefaction reactor 224.

Torrefaction reactor 224 may include any oven, kiln, or other suitable heating apparatus suitable for heating biomass to a desired temperature (e.g., approximately 230° C. to approximately 300° C.) and for a desired period of time (e.g., approximately 15 minutes to approximately 30 minutes) in a substantially oxygen-deprived environment (e.g., an oxygen content at or below approximately 2% in some embodiments) for torrefying biomass. Torrefaction reactor 224 may include a suitable conveyor for conveying biomass (e.g., including a substantially continuous stream of biomass) from an input of torrefaction reactor 224 (e.g., proximate to airlock 219) to an output of torrefaction reactor (e.g., proximate to airlock 228). As shown in FIG. 2, and described in greater detail below, torrefaction reactor 224 may receive heat from via heat transfer system 226. Heat received via heat transfer system 226 may be used to heat biomass in torrefaction reactor 224 via conductive, convective, and/or radiant heat transfer.

Heat transfer system 226 may be any suitable device configured to transfer heat from a thermally-conductive conduit coupled between furnace 222 and heat transfer system 226. Accordingly, heat generated by furnace 222 may be transferred via the conduit by air (e.g., by means of a fan or blower), thermally-conductive oil, or other fluid present in the conduit, from which it may be transferred to torrefaction reactor 224 via heat transfer system 226. In certain embodiments, heat transfer system 226 may use electric block heaters directly attached to torrefaction reactor 224 and the heat from furnace 222 may be used to create electricity for the block heaters as opposed to provide heat directly to torrefaction reactor 224.

Airlock 228 may comprise any device that may permit the passage of biomass between torrefaction reactor 224 and stabilizer/conditioner 230 while minimizing exchange of gas between the space internal to torrefaction reactor 224 and stabilizer/conditioner 230, in order to prevent air in the space internal to torrefaction reactor 224 mixing significantly with air in the space internal to stabilizer/conditioner 230. For example, airlock 228 may include an airlock, feeder, load lock, or other suitable device. In certain embodiments, airlock 228 may comprise a rotary airlock, thus permitting substantially continuous conveyance of biomass from torrefaction reactor 224 to stabilizer/conditioner 230.

As depicted in FIG. 2, the combination of preheater 218 and torrefaction reactor 224 may provide for a multiple-phase torrefaction process. For example, the combination of preheater 218 and torrefaction reactor 224 may provide for a two-phase torrefaction process. In the first phase, preheater 218 may heat biomass from a first temperature (e.g., approximately 50° C. to approximately 60° C.) to a second temperature (e.g., approximately 230° C. to approximately 280° C.), wherein the first temperature is the temperature of biomass at an input of preheater 218 and the second temperature is an approximate desired torrefaction temperature, In the second phase, torrefaction reactor 224 may maintain biomass at or about (e.g., within approximately 20° C.) of the second temperature (e.g., approximately 230° to approximately 300° C.).

As another example, the combination of preheater 218 and torrefaction reactor 224 may provide for a three-phase torrefaction process. In such a process, preheater 218 may be divided into two portions, which may be thermally isolated from one another by an airlock or other appropriate device. In the first phase, the first portion of preheater 218 may heat biomass from a first temperature (e.g., approximately 50° to approximately 60° C.) to a second temperature (e.g., approximately 200° C.) over a particular period (e.g., approximately 5 minutes to approximately 15 minutes), wherein the first temperature is the temperature of biomass at an input of preheater 218 and the second temperature is may be a temperature at which moisture from biomass may be evaporated, but below a temperature at which the biomass may release significant amounts of volatile organic compounds.

In the second phase, the second portion of preheater 218 may heat biomass from the second temperature (e.g., approximately 200° C.) to a third temperature (e.g., approximately 230° to approximately 280° C.) over a particular period of time (e.g., approximately 15 to approximately 30 minutes), wherein the third temperature is an approximate desired torrefaction temperature. In the third phase, torrefaction reactor 224 may maintain biomass at or about (e.g., within approximately 20° C.) of the third temperature (e.g., approximately 230° to approximately 300° C.).

In some embodiments of torrefaction system 200, preheater 218 may not be present (e.g., such that torrefaction reactor 224 is coupled to airlock 216), thus providing for a single-stage torrefaction process. In such embodiments, may heat biomass from a temperature of approximately 50 to approximately 60° F. at its input to approximately 230° C. to approximately 300° C. at its output.

In certain application, a multi-stage torrefaction process may be preferred because it may provide for desired decomposition of certain components of the biomass while reducing or eliminating decomposition of other components as compared with a single-stage process. For example, it may be desirable to prevent decomposition of lignin in the biomass, as lignin may provide desirable properties in torrefied biomass, including acting as a binding agent for densifying (e.g., pelleting and/or briquetting) torrefied biomass. The two-stage torrefaction process herein may allow a dehydration reaction of hemicellulose present in biomass to occur at a temperature below that at which lignin present in the biomass is reactive, while the single-stage process as described herein may lead to substantial decomposition of lignin. Thus, the two-stage process provides for a first region in which biomass may be heated to a desired temperature, and then a second region in which the biomass may be held at the desired temperature for long periods of time to provide for desired decomposition of certain components (e.g., hemicellulose) while possibly reducing the likelihood of overtorrefying (e.g., decomposing lignin or other components that may be desirable to retain) or the likelihood of the biomass reaching a temperature at which it may undergo an undesirable exothermic reaction.

A three-stage torrefaction process such as the one disclosed above may also provide additional advantages. The first portion of preheater 218 may allow heating of biomass to a temperature above which evaporation of moisture content will occur, but below that at which the biomass will generate significant amounts of volatile organic compounds. The second portion may allow heating at a higher temperature above which significant generation of volatile organic compounds occurs but below that at which significant torrefaction of the biomass occurs. Accordingly, because significant generation of volatile organic compounds may occur in a portion of preheater 218, rather than throughout preheater 218, handling of volatile organic compounds may be simplified. Also, because torrefection may require careful control of various temperatures in the torrefection process, a two-part heating process in preheater 218 may allow for simplification of controls for heating biomass.

In each of the single-phase and multiple-phase torrefaction processes described above, heating of biomass by torrefaction reactor 224 may cause torrefaction of biomass, in which an approximate 10% reduction in energy content of the biomass and an approximate 30% reduction in mass of the biomass may occur. The reduction in energy content may be caused primarily by the partial decomposition of the biomass, which may give off volatile organic compounds. As shown in FIG. 2, such torgas may be exhausted from torrefaction reactor 224 via a suitable conduit, such that the torgas may circulate to be used as fuel for furnace 222. In addition, in embodiments in which it is present, preheater 218 may also exhaust torgas via suitable conduits, such that torgas exhausted by preheater 218 may circulate to be used as a fuel for furnace 222. Such use of torgas as a fuel for furnace 222 may render system 200 a largely autothermal torrefaction system.

In addition to being delivered from preheater 218 and/or torrefaction reactor 224 to furnace 222 as a fuel, torgas may also, in some embodiments, be refined and/or segregated into its component gasses, which may then be stored, sold and/or used for fuel for applications other than for use in system 200.

As described above, a reduction in mass of biomass during torrefaction may be caused by a reduction in the moisture content in the biomass or the volatilization of organic compounds. For example, torrefaction in torrefaction reactor 224 may reduce the moisture content of the biomass from less than approximately 10% to less than approximately 2%. Such moisture may be given up in the form of vapor, which may be exhausted to the environment (e.g., via a stack or other appropriate exhaust) to the environment.

As set forth above, dryer 202, preheater 218, and torrefaction reactor 224 may be supplied with heat from furnace 222. Furnace 222 may comprise any suitable system configured to combust a plurality of different fuels to generate heat. For example, in some embodiments, furnace 222 may be configured to combust biomass produced at one or more steps of method 100 (e.g., out-of-spec material, oversized chips, and/or particulates from receiving 114, screening 116, milling 118, and milling 120, and/or torrefied biocoal and/or out-of-spec densified pellets or briquettes from densifier 234) and torgas produces by preheater 218 and/or torrefaction reactor 224, thus providing a predominantly autothermal system that requires relatively little or no fuel other than that obtained from harvested biomass. In certain of such embodiments, furnace 222 may be further configured to burn natural gas or another “traditional” fuel, and may use such traditional fuel for initial startup (e.g., to ramp up to a steady-state operational state) or in instances in which insufficient biomass products are available for burning at desired operational states, and such traditional fuel may be reduced once steady-state operation has been achieved and/or sufficient biomass-based fuel is available. In addition, in these and other embodiments, furnace 222 may be configured to receive and incinerate VOCs and/or particulate matter separated by separator 206, thus potentially reducing or eliminating any need to emit such VOCs and/or particulate matter into the environment. In the embodiments set forth above and other embodiments, furnace 222 may comprise any commercially available biomass furnace.

Thus, furnace 222 may receive its fuel from three sources (e.g., biomass, torgas, and some fraction of traditional fuel for start up). As used in system 200, furnace 222 may serve two functions: a) to produce heat required for dryer 204, preheater 218, and torrefaction reactor 224, and b) to incinerate virtually all VOCs and particulate matter from preheater 218 and torrefaction reactor 224 and/or at least a portion of VOCs separated by separator 206. The heat from furnace 222 is shared among dryer 204 which requires both a mass of air and high temperature and preheater 218 and torrefaction reactor 224. Furnace 222 may maintain a high enough temperature to incinerate VOCs, while providing the necessary heat for components of system 200. Accordingly, dryer 204, torrefaction reactor 224, and (when present) preheater 218, may form an integrated torrefaction system. Thus, while each component of the integrated system is a discrete component, the mass and energy balance, fuel supply, heat transfer, emissions control, and operation are shared in a way to optimize overall performance of the integrated system.

Airlock 228 and/or suitable conveyor may convey torrefied biomass from torrefaction reactor 224 to stabilizer/conditioner 230. Stabilizer/conditioner 230 may be any device configured to substantially simultaneously stabilize torrefied biomass to reduce or eliminate the possibility of spontaneous combustion while preparing or conditioning the torrefied biomass for densification. Stabilization of torrefied biomass may include cooling the torrefied biomass, as the temperature at which the biomass is torrefied in torrefaction reactor 224 may be at or above the flash point of the biomass, meaning exposure of the biomass to ambient air at the completion of torrefaction without cooling may cause combustion due to oxygen content in the air. Conditioning of torrefied biomass may include modifying one or more characteristics of the biomass to improve or maintain suitability of the biomass for densification. For example, conditioning may include increasing moisture content in the torrefied biomass (e.g., to between approximately 5% to approximately 15%) which may act as a lubricant during densification. Such increase in moisture content may also cause a cessation of thermochemical reactions that take place in the biomass during torrefaction. Conditioning may also include maintaining the biomass above a particular temperature in order to achieve properties desirable for densification. For example, maintaining biomass at a temperature above approximately 80° C. may allow lignin present in the biomass to remain soft and pliable, enabling the lignin to act as a natural binding agent during densification. Accordingly, substantially simultaneous stabilization and conditioning may not only stabilize torrefied biomass, but may also reduce or eliminate a need for a separate conditioning step prior to densification.

To substantially simultaneously stabilize and condition torrefied biomass, stabilizer/conditioner 230 may apply water and/or other liquid to torrefied biomass while the torrefied biomass is at or near its temperature of torrefaction (e.g., approximately 230° C. to approximately 300° C.). Such spraying of liquid upon biomass may cause cooling of biomass and generation of steam as the fluid evaporates due to heat transfer from the torrefied biomass. This generation of steam may further prevent combustion of the torrefied biomass, as steam generation may force any oxygen present in stabilizer/conditioner 230 away from the biomass. In addition, application of water to cool biomass may also condition biomass for densification.

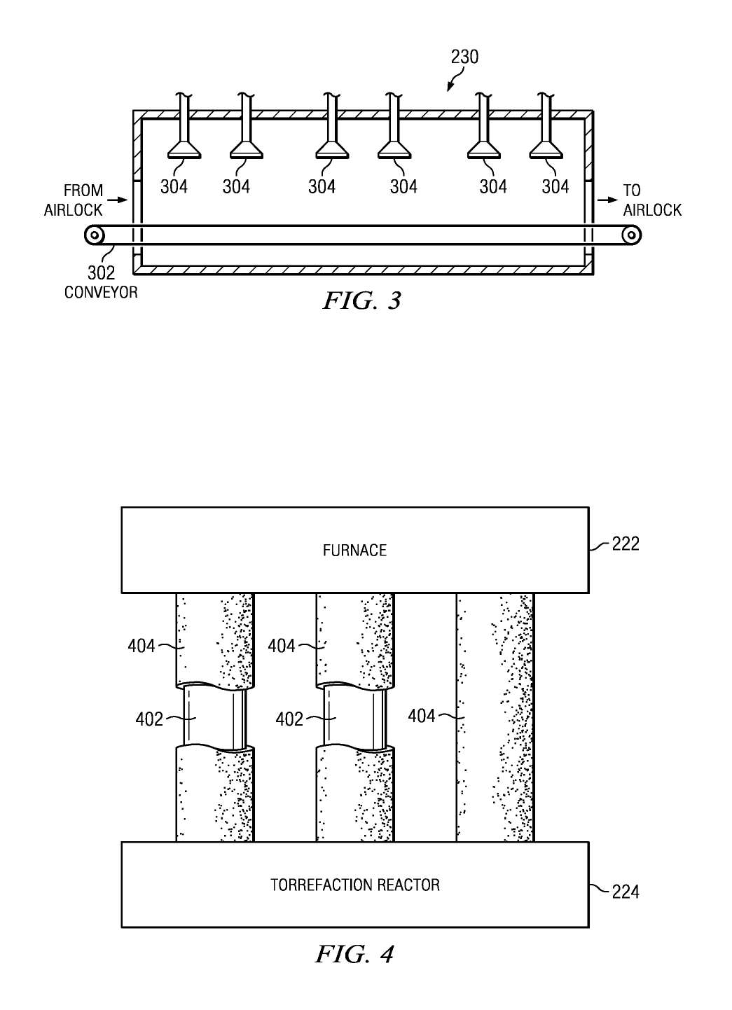

FIG. 3 illustrates a schematic diagram of an example stabilizer/conditioner 230, in accordance with certain embodiments of the present disclosure. As shown in FIG. 3, stabilizer/conditioner 230 may include a conveyor 302 and one or more liquid application apparatuses 304. Conveyor 302 may include a chain conveyor, belt conveyor, drag conveyor, vibratory conveyor, walking-floor conveyor, piston conveyor, screw conveyor, pneumatic transfer conveyor, and/or any other suitable conveyance system for transporting torrefied biomass during stabilizing/conditioning. Each of the one of more liquid application apparatuses 304 may be coupled to a source of water or other fluid (not shown) and may be configured to apply water or other fluid to biomass as conveyor 302 conveys torrefied biomass through stabilizer/conditioner 230. In some embodiments, a liquid application apparatus may comprise a spray nozzle.

Returning to FIG. 2, airlock 231 may comprise any device that may permit the passage of biomass between stabilizer/conditioner 230 and intermediate storage 232 while minimizing exchange of gas between the space internal to stabilizer/conditioner 230 and the space external to stabilizer/conditioner 230, in order to ensure the space internal to stabilizer/conditioner 230 remains a substantially oxygen-deprived environment (e.g., an oxygen content at or below approximately 2% in some embodiments). For example, airlock 231 may include an airlock, feeder, load lock, or other suitable device. In certain embodiments, airlock 231 may comprise a rotary airlock, thus permitting substantially continuous conveyance of biomass from stabilizer/conditioner 230 to intermediate storage 232.

A suitable conveyor may convey stabilized and conditioned torrefied biomass to intermediate storage 232. Intermediate storage 232 may include any suitable container for temporarily storing biomass prior to conveyance to densifier 234. In some embodiments, intermediate storage 232 may comprise a surge bin.

A suitable conveyor may convey stabilized and conditioned torrefied biomass from intermediate storage 232 to densifier 234. Densifier 234 may comprise any apparatus configured for densifying torrefied biomass that it receives to form pellets, briquettes, and/or another suitable densified form of torrefied biomass. For example, in certain embodiments, densifier may include CPM Model 3016-4 Pellet Mill manufactured by California Pellet Mill Co. In addition, a selected die may be used in densifier 234 to produce pellets and/or briquettes of a desired size and/or shape.

After densification, pellets and/or briquettes may be subject to further processes. For example, pellets and/or briquettes may be subjected to cooling, to reduce an increase in temperature of the pellets and/or briquettes caused by friction that may be present in the densification process. Such cooling may be carried out in any suitable manner, including cooling by ambient air in a traditional pellet cooler, surge bin, or other storage container. Following cooling, screening may be applied to pellets or briquettes. Screening may be performed by one or more screens, and/or other similar device capable of removing out-of-spec pellets or briquettes (e.g., segregating pellets or briquettes unsuitable for commercial distribution). Those pellets or briquettes deemed out of specification for commercial distribution may be supplied to furnace 222 as fuel or may be recycled for re-densification. After screening, those pellets and/or briquettes deemed suitable for commercial distribution may be stored in bulk (e.g., a bins, containers, or in piles) until shipped to its intended destination. Torrefied biomass is hydrophobic, permitting storage in numerous environments.

In certain embodiments, for example the embodiments depicted in FIG. 4, the arrangement of torrefaction reactor 224, furnace 222, and conduits coupling the two may minimize the effect of corrosive gasses and/or undesirable condensation or collection of substances in such conduits. FIG. 4 illustrates a schematic diagram depicting an example arrangement of selected components of the torrefaction system 200, in accordance with certain embodiments of the present disclosure. As mentioned above, the torgas released by torrefaction may include VOCs. Such VOCs may include pollutants and other compounds that may condense from gas phase to liquid phase or solid phase and collect in conduits 402 coupling torrefaction reactor 224 to furnace 222, potentially leading to obstruction of conduits 402 and requiring cleaning, or necessitating the use of more expensive conduit materials.

To prevent such potential problems, furnace 222 and torrefaction reactor 224 may be arranged in system 200 such that furnace 222 is coupled to torrefaction reactor 224 via conduits 402 for passage of torgas from torrefaction reactor 224 to furnace 222, wherein each conduit 402 may be of any suitable length such that any cooling of torgas that takes place as the torgas passes from the bottom to the top of conduits 402 is insufficient to permit substantial condensation of torgas from gas phase to liquid or solid phase. In addition, each conduit 402 may be insulated by a jacket 404 or other insulator configured to prevent heat from escaping conduits 402 to the ambient environment thereby potentially lowering the internal surface of conduit 402 below the dew point of the torgas. Moreover, each conduit may be heated (e.g., by heat from furnace 222) such that the temperature of the torgas internal to each conduit 402 is maintained above the dew point of the torgas. Such arrangement of conduits 402 may prevent or reduce collection of undesired deposits within conduits 402 for numerous reasons. By jacketing, heating, and/or and maintaining conduits 402 at a relatively short length, the internal temperature within conduits 402 may prevent condensation from the gas phase of undesired particulates, and such particulates may instead flow to furnace 222, where they may be consumed as fuel or otherwise combusted by furnace 222.

In addition, in some embodiments, furnace 222 and torrefaction reactor 224 may be arranged in system 200 such that furnace 222 is located substantially vertically above torrefaction reactor 224, with the plurality of conduits 402 oriented substantially vertically between torrefeaction reactor 224 and furnace 222 and providing a path for passage of torgas. Such substantially vertical orientation of conduits 402 may advantageously leave the space internal to each conduit 402 without a horizontal surface upon which undesired particulates may accumulate.

In addition, the presence of a plurality of conduits 402 provides for redundancy of conduits 402, such that to the extent a conduit 402 requires maintenance, cleaning, or replacement, the remainder of conduits 402 may maintain a path for the delivery of torgas during the time of such maintenance, cleaning, or replacement. To facilitate such replacement, maintenance or cleaning, each conduit 402 may interface to each of torrefaction reactor 224 and furnace 222 via a valve (not shown), and such valve may be set in a closed position during such service.

FIG. 5 illustrates a flow diagram of an example torrefaction and densification process, in accordance with certain embodiments of the present disclosure. In step 502, biomass may be conveyed to a preheater (e.g., preheater 218). In step 504, biomass may be heated in the preheater from a first temperature (e.g., from approximately 50° C. to approximately 60° C.) to an approximate desired torrefaction temperature (e.g., from approximately 230° C. to approximately 280° C.). In some embodiments, heating in step 504 may occur in two phases. In the first phase, the preheater may heat biomass from the first temperature to a second temperature (e.g., approximately 200° C.) over a particular period (e.g., approximately 5 minutes to approximately 15 minutes). In the second phase, the preheater may heat biomass from the second temperature (e.g., approximately 200° C.) to approximate desired torrefaction temperature (e.g., approximately 230° to approximately 280° C.) over a particular period of time (e.g., approximately 15 to approximately 30 minutes).

At step 506, torgas generated in the preheater may be circulated, via any suitable conduit, to a furnace providing heat to the preheater via any suitable conduit. At step 508, biomass may be conveyed to a torrefaction reactor (e.g., torrefaction reactor 224). At step 510, the biomass may be maintained at or about the approximate desired torrefaction temperature approximately 230° to approximately 300° C.) over a particular period of time (e.g., approximately 15 to approximately 30 minutes). At step 512, torgas generated in the torrefaction reactor may be circulated, via any suitable conduit, to a furnace providing heat to the torrefaction reactor.

At step 514, biomass may be conveyed to a stabilizer/conditioner (e.g., stabilizer/conditioner 230). At step 516, the biomass may be substantially simultaneously stabilized and conditioned. In certain embodiments, the stabilizer/conditioner may apply water or other liquid to the biomass in order to achieve substantial simultaneous stabilizing and conditioning.

At step 518, biomass may be conveyed to a densifier (e.g., densifier 234). At step 520, the densifier may densify (e.g., by pelleting or briquetting) the biomass.

Although FIG. 5 discloses a particular number of steps to be taken with respect to method 500, method 500 may be executed with greater or lesser steps than those depicted in FIG. 5. In addition, although FIG. 5 discloses a certain order of steps to be taken with respect to method 500, the steps comprising method 500 may be completed in any suitable order.

Modifications, additions, or omissions may be made to method 100, system 200, and method 500 from the scope of the disclosure. The components of system 200 may be integrated or separated. Moreover, the operations of system 200 may be performed by more, fewer, or other components. As used in this document, “each” refers to each member of a set or each member of a subset of a set.

Although the present disclosure has been described with several embodiments, various changes and modifications may be suggested to one skilled in the art. It is intended that the present disclosure encompass such changes and modifications as fall within the scope of the appended claims.

What is claimed is:

1. A system, comprising:
a preheater configured to heat biomass from a first temperature to an approximate desired torrefaction temperature;
a torrefaction reactor configured to maintain heating of the biomass at approximately the approximate desired torrefaction temperature for a particular period of time to generate torrefied biomass; and
a furnace configured to generate and convey via one or more conduits heat to the preheater, and the torrefaction reactor.

2. The system of claim 1, wherein the preheater and the torrefaction reactor are thermally isolated.

3. The system of claim 1, wherein the first temperature is between approximately 50 degrees Celsius and approximately 60 degrees Celsius.

4. The system of claim 1, wherein the approximate desired torrefaction temperature is between approximately 230 degrees Celsius and approximately 280 degrees Celsius.

5. The system of claim 1, further comprising a dryer configured to decrease moisture content of the biomass prior to heating of the biomass by the preheater.

6. The system of claim 1, further comprising:
a separator configured to segregate biomass present in the dryer from at least one of biomass particulates, vapor, and volatile organic compounds present in the dryer; and
a conduit configured to convey the at least one of biomass particulates, vapor, and volatile organic compounds present in the dryer to the furnace for combustion.

7. The system of claim 1, the torrefaction reactor configured to maintain heating of the biomass within approximately 20 degrees Celsius of the approximate desired torrefaction temperature.

8. The system of claim 1, the preheater comprising:
a first portion configured to heat the biomass from the first temperature to a second temperature; and
a second portion configured to heat the biomass from the second temperature to approximately the approximate desired torrefaction temperature

9. The system of claim 1, the furnace further configured to combust one or more volatile organic compounds generated by at least one of the preheater and the torrefaction reactor to generate at least a portion of the heat.

10. The system of claim 9, the furnace further configured to combust biomass to generate at least a portion of the heat.

11. The system of claim 1, further comprising a stabilizer/conditioner configured to substantially simultaneously stabilize and condition the torrefied biomass.

12. The system of claim 11, the stabilizer/conditioner configured to substantially simultaneously stabilize and condition the torrefied biomass by applying a liquid to the torrefied biomass.

13. The system of claim 1, further comprising a densifier to densify the torrefied biomass.

14. A system, comprising:
a torrefaction reactor configured to heat biomass generate torrefied biomass; and
a stabilizer/conditioner configured to substantially simultaneously stabilize and condition the torrefied biomass.

15. The system of claim 14, the stabilizer/conditioner configured to substantially simultaneously stabilize and condition the torrefied biomass by applying a liquid to the torrefied biomass.

16. The system of claim 14, wherein simultaneously stabilizing and conditioning the torrefied biomass comprises substantially simultaneously:
cooling the torrefied biomass; and
increasing the moisture content of the torrefied biomass.

17. The system of claim 14, wherein cooling the torrefied biomass comprises maintaining the torrefied biomass above a minimum temperature.

18. The system of claim 17, wherein the minimum temperature is approximately 80 degrees Celsius.

19. A method, comprising:
heating, in a torrefaction reactor, biomass to generate torrefied biomass;
generating and conveying via one or more heat conduits heat from a furnace to the torrefaction reactor;
combusting, in the furnace, one or more volatile organic compounds generated by the torrefaction reactor to generate at least a portion of the heat;
circulating, via one or more fluid conduits, the one or more volatile organic compounds from the torrefaction reactor to the furnace; and
heating the one or more fluid conduits such that a temperature of the volatile organic compounds while present in the one or more fluid conduits remains above a dew point of the volatile organic compounds.

20. The method of claim 19, further comprising arranging the torrefaction reactor, the furnace, and the one or more conduits such that:
the furnace is located substantially vertically above the torrefaction reactor; and
at least one conduit of the one or more fluid conduits are arranged such that longitudinal axis of the at least one conduit is substantially vertical, such that the at least one fluid conduit substantially includes only vertical surfaces internal to the at least one fluid conduit.
